(19) United States
(12) Patent Application Publication
(10) Pub. No.: US 2013/0121312 A1
(43) Pub. Date: May 16, 2013

(54) Transmission of Channel State Information

(71) Applicants: Timo E. Roman, Espoo (FI); Tommi T. Koivisto, Espoo (FI); Mihai Enescu, Espoo (FI); Karol Schober, Helsinki (FI)

(72) Inventors: Timo E. Roman, Espoo (FI); Tommi T. Koivisto, Espoo (FI); Mihai Enescu, Espoo (FI); Karol Schober, Helsinki (FI)

(73) Assignee: Renesas Mobile Corporation

(21) Appl. No.: 13/299,810

(22) Filed: Nov. 18, 2011

(30) Foreign Application Priority Data
Nov. 14, 2011 (GB) 1119688.8

(51) Int. Cl. H04W 72/10

(52) U.S. Cl. 370/335

(57) ABSTRACT

Signalling information relating to Multiple Input Multiple Output MIMO channel state information characteristics that a user equipment UE determines to be highest priority for a downlink is transmitted uplink from a the UE to a node of a cellular wireless network. The UE receives an indicator from the node indicating a preferred basis of the highest priority signalling information. The UE compiles the highest priority signalling information according to the preferred basis, and sends the compiled signalling information to the node. If the UE determines that the number of MIMO layers preferred for use for the downlink is one, then signalling information is sent in different messages indicating a first and second codeword respectively, the first codeword being selected to be a closest codeword to an intended MIMO channel state information characteristic, and the second characteristic is selected to be a less close codeword.

### TECHNICAL FIELD

The present invention relates generally to wireless systems, and more specifically, but not exclusively, to a method and apparatus relating to transmission of channel state information in a cellular wireless network using a Multiple Input Multiple Output transmission format.

### BACKGROUND

Cellular wireless networks typically comprise user equipments (UE) such as mobile handsets which may communicate via a network interface comprising a radio transceiver to a network of base stations connected to a telecommunications network. Such cellular wireless networks have undergone rapid development through a number of generations of radio access technology. The initial deployment of systems using analogue modulation has been superseded by second generation (2G) digital systems such as GSM (Global System for Mobile communications), implementing GERAN (GSM Enhanced Data rates for GSM Evolution Radio Access Network) radio access networks, and these systems have themselves been replaced by or augmented by third generation (3G) digital systems such as UMTS (Universal Mobile Telecommunications System), implementing the UTRAN (Universal Terrestrial Radio Access Network) radio access networks. Third generation standards provide for a greater throughput of data than is provided by second generation systems; this trend is continued with the introduction of High Speed Packet Access (HSPA), which may augment third generation systems, providing a high capacity packet switched downlink, and Long Term Evolution (LTE) and LTE advanced systems. HSPA and LTE typically use adaptive modulation and coding to provide increased capacity when a channel has a good quality, for example a high signal to noise ratio. In a system using adaptive modulation and coding, a succession of Channel Quality Indicators (CQIs) is typically fed back from a receiver, typically at a user equipment, to a serving node for use in determining a transmission format, which may include a type of modulation and a type of coding, for use on a downlink from the node to the user equipment. Multiple transmitter schemes, such as MIMO (multiple input, multiple output) may be used with HSPA, LTE, and other wireless transmission formats. A multiple transmitter scheme may use multiple transmit antennas to provide a number of transmission streams, one or more or all of which may be received at a given user equipment, providing potentially greater capacity than a single transmitter scheme. More than one transmission stream may be sent to a single user equipment, in a so-called Single User MIMO (SU-MIMO) scheme, or transmissions streams may be used to send data to different users, in a Multi-User MIMO scheme. A transmission stream may correspond to a transmitted beam, and may be referred to as a layer, and beams may overlap spatially. MIMO schemes may be used as part of a transmission format using adaptive modulation and coding, for example in a LTE system. Channel State Information (CSI) is typically fed back from a user equipment to a serving node to indicate a MIMO channel state information characteristic that the user equipment determines to be highest priority for a downlink, including information relating to a number of multiple transmitter transmission streams, i.e. MIMO rank, on which data intended for the user equipment is to be transmitted, a so-called Rank Indicator (RI). The CSI typically includes a Channel Quality Indicator (CQI), and also a Pre-coding Matrix Index (PMI), which that may represent amplitude and phase weighting to be applied at each antenna, typically in the form of codewords form a codebook listing allowed pre-defined states which may be communicated with fewer bits than would be required to communicate an arbitrary PMI value. CQI and PMI information may apply to a whole band used for transmission by a carrier, or to a sub-band which is narrower than the whole band.

It may be seen that there are many permutations of MIMO rank, and CQI and PMI sub-banding or non-sub-banding that may be used as a basis of a CSI report.

Existing CSI reporting schemes may involve using one or more predetermined basis for reporting, which may include alternating reports compiled on different respective bases. However, the pre-determined reporting basis may not be appropriate to a particular use of the link, for example, single user and multi-user MIMO may have quite different requirements in terms of rank and sub-banding or non-sub-banding of CQI and PMI. Pre-determined reporting options may be more suited to semi-static MIMO configuration and scheduling of SU-/MU-MIMO in the system, but may be sub-optimal when more dynamic SU-/MU-MIMO scheduling is performed, for example on a per sub-frame basis, which may depend on traffic conditions, multi-user diversity, spatial separation of the users, etc. Furthermore, alternation between pre-defined reporting bases may be inefficient in that it may induce redundancy in channel state information feedback, in particular when the alternating schemes each happen to refer to the same rank.

It is an object of the invention to address at least some of the limitations of the prior art systems.

### SUMMARY

In accordance with a first exemplary embodiment of the present invention, there is provided a method of transmitting, via a radio communications uplink from a user equipment to a node of a cellular wireless network, signalling information relating to Multiple Input Multiple Output channel state information characteristics, that the equipment determines to be highest priority for a downlink, the method comprising:

receiving an indicator from the node indicating a preferred basis of the highest priority signalling information;

compiling the highest priority signalling information according to the preferred basis; and

sending the compiled signalling information to the node.

In accordance with a second exemplary embodiment of the present invention, there is provided a user equipment for transmitting to a node of a cellular wireless network, via a radio communications uplink, signalling information relating to Multiple Input Multiple Output channel state information characteristics, that the equipment determines to be highest priority for a downlink, the user equipment comprising at least one processor and at least one memory including computer program code, the at least one memory and the computer program code configured to, with the at least one processor, cause the user equipment to:

receive an indicator from the node indicating a preferred basis of the highest priority signalling information;

compile the highest priority signalling information according to the preferred basis; and

send the compiled signalling information to the node.

In accordance with a third exemplary embodiment of the present invention, there is provided a node of a cellular wireless network for receiving from a user equipment, via a radio communications uplink, signalling information relating to Multiple Input Multiple Output channel state information characteristics, that the equipment determines to be highest priority for a downlink, the node comprising at least one processor and at least one memory including computer program code, the at least one memory and the computer program code configured to, with the at least one processor, cause the node to:

send an indicator to the user equipment indicating a preferred basis of the highest priority signalling information; and

receive signalling information compiled by the user equipment according to the preferred basis.

In accordance with a fourth exemplary embodiment of the present invention, there is provided a computer program product comprising a non-transitory computer-readable storage medium having computer readable instructions stored thereon, the computer readable instructions being executable by a computerized device to cause the computerized device to perform a method for transmitting, via a radio communications uplink from a user equipment to a node of a cellular wireless network, signalling information relating to Multiple Input Multiple Output channel state information characteristics, that the equipment determines to be highest priority for a downlink, the method comprising:

receiving an indicator from the node indicating a preferred basis of the highest priority signalling information;

compiling the highest priority signalling information according to the preferred basis; and

sending the compiled signalling information to the node.

In accordance with a fifth exemplary embodiment of the present invention, there is provided a method of transmitting, via a radio communications uplink from a user equipment to a node of a cellular wireless network, signalling information relating to a Multiple Input Multiple Output channel state information characteristics for a downlink, the method comprising:

determining a preferred rank of Multiple Input Multiple Output communication which is a number of Multiple Input Multiple Output layers that the user equipment would prefer to be used for the downlink; and

dependent on the preferred rank being a rank of one, sending said signalling information in different messages indicating a first and second codeword respectively,

wherein the first codeword is selected from a codebook to be a closest codeword in the codebook to a representation of an intended Multiple Input Multiple Output channel state information characteristic, and the second characteristic is selected to be a less close codeword in the codebook to the representation of the intended Multiple Input Multiple Output channel state information characteristic.

In accordance with a sixth exemplary embodiment of the present invention, there is provided a user equipment for transmitting to a node of a cellular wireless network, via a radio communications uplink, signalling information relating to a Multiple Input Multiple Output channel state information characteristic for a downlink, the user equipment comprising at least one processor and at least one memory including computer program code, the at least one memory and the computer program code configured to, with the at least one processor, cause the user equipment to:

determine a preferred rank of Multiple Input Multiple Output communication which is a number of Multiple Input Multiple Output layers that the user equipment would prefer to be used for the downlink; and

dependent on the preferred rank being a rank of one, send said signalling information in different messages indicating a first and second codeword respectively,

wherein the first codeword is selected from a codebook to be a closest codeword in the codebook to a representation of the an intended Multiple Input Multiple Output configuration characteristic, and the second characteristic is selected to be a less close codeword in the codebook to the representation of the intended Multiple Input Multiple Output configuration characteristic.

In accordance with a seventh exemplary embodiment of the present invention, there is provided a computer program product comprising a non-transitory computer-readable storage medium having computer readable instructions stored thereon, the computer readable instructions being executable by a computerized device to cause the computerized device to perform a method for transmitting, via a radio communications uplink from a user equipment to a node of a cellular wireless network, signalling information relating to a Multiple Input Multiple Output channel state information characteristic for a downlink, the method comprising, the method comprising:

determining a preferred rank of Multiple Input Multiple Output communication which is a number of Multiple Input Multiple Output layers that the user equipment would prefer to be used for the downlink; and

dependent on the preferred rank being a rank of one, sending said signalling information in different messages indicating a first and second codeword respectively,

wherein the first codeword is selected from a codebook to be a closest codeword in the codebook to a representation of an intended Multiple Input Multiple Output configuration characteristic, and the second characteristic is selected to be a less close codeword in the codebook to the representation of the intended Multiple Input Multiple Output configuration characteristic.

Further features and advantages of the invention will be apparent from the following description of preferred embodiments of the invention, which are given by way of example only.

### BRIEF DESCRIPTION OF THE DRAWINGS

FIG. 1 is a schematic diagram showing a radio access network according to an embodiment of the invention;

FIG. 2 is a flow diagram of a method according to an embodiment of the invention;

FIG. 3 is a diagram illustrating signal flow in an embodiment of the invention;

FIG. 4 is a diagram illustrating determination of closest and second closest codewords in an embodiment of the invention;

FIG. 5 is a diagram illustrating interpolation between closest, second closest and third closest codewords in an embodiment of the invention;

FIG. 6 is a flow diagram of a method according to an embodiment of the invention;

FIG. 7 is a schematic diagram of a user equipment in an embodiment of the invention; and

FIG. 8 is a schematic diagram of a node of a cellular wire network in an embodiment of the invention.

### DETAILED DESCRIPTION

By way of example an embodiment of the invention will now be described in the context of a 3GPP wireless communications system supporting communication using LTE radio access technology. However, it will be understood that this is by way of example only and that other embodiments may involve wireless networks using other radio access technologies, such as HSPA or IEEE802.16 WiMax systems.

Existing LTE systems may be specified for use with a multiple transmitter communications link, such as a MIMO (multiple input, multiple output) scheme. For example, a MIMO scheme has been specified using four antennas at the base station as well as at the user equipment to provide four transmissions streams, which may be referred to as layers or components, and which may be beamformed spatial beams. For example, LTE Releases 8 and 9 support up to four antennas at eNodeB, while from LTE Release 10 onwards, up to eight antennas and eight streams/layers are supported. The number of layers transmitted to a particular UE may be referred to as a transmission rank for that particular UE. The streams may overlap in space, so that one or both of the streams may be received at a user equipment, and if both are received, this may be used to provide additional data capacity compared to the capacity of a single stream. In addition, adaptive modulation and coding may be used, and so, depending on channel quality, there are a variety of possible configurations of the downlink in terms of number of transmission streams and modulation and coding formats. The user equipment periodically sends Channel State Information (CSI), which is signalling information relating to Multiple Input Multiple Output channel state information characteristics, to the serving node, typically a NodeB, on the basis of measurements of downlink channel quality at the user equipment. The signalling information relating to Multiple Input Multiple Output channel state information characteristics may be signalling information that the user equipment determines to be highest priority for a downlink. The signalling information may typically represent channel state information which the user equipment has determined as optimum, rather than channel state information that is intended for use as a fallback position. The Channel State Information typically includes a Channel Quality Indicators (CQI) to indicate a transmission format for use on the downlink, a Precoding Matrix Index (PMI), that may represent amplitude and phase weighting to be applied at each transmit antenna, typically in the form of codewords form a codebook listing allowed pre-defined states, and a rank indicator (RI) that indicates a number of MIMO layers to be configured. The reported PMI and/or CQI included in channel state information are typically conditional on the reported RI. A MIMO scheme may be configured as a Single-User MIMO scheme or a Multi-User MIMO scheme, and single user and multi-user MIMO may have quite different requirements in terms of desired characteristics of the reported CSI, especially related to the MIMO rank and sub-banding or not of CQI and PMI reporting. A lower and restricted maximum rank, typically 1, may be preferred for a MU-MIMO scheme, but non-restricted and potentially higher maximum rank may be preferred for a SU-MIMO scheme.

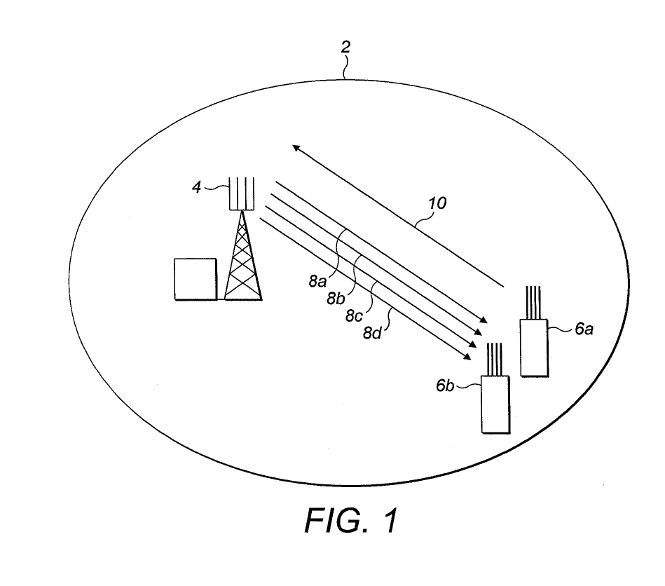

FIG. 1 is a schematic diagram showing part of a cellular wireless network 2 according to an embodiment of the invention. A node of the network, base station serving node eNB 4, sends four components 8a, 8b, 8c, 8d of a radio communications link from the node to a user equipments 6a. The components may be transmission streams of a MIMO transmission. The user equipment 6a sends indications of Multiple Input Multiple Output downlink characteristics, for example Channel State Information, to the node, via a radio communications uplink 10. The signalling information may be MIMO channel state information that the user equipment determines to be highest priority for the downlink. The MIMO scheme may be a single-user MIMO scheme, in which all four of the transmission streams, in the example of FIG. 1, may carry data intended for the user equipment 6a. Alternatively, the MIMO scheme may be a multi-user MIMO scheme, and, for example, one MIMO transmission stream may be used to carry data to a first user equipment 6a, and another MIMO transmission stream may be used to carry data to a second user equipment 6b.

In an embodiment of the invention, an indicator is received at a user equipment from a node, such as an eNB of a cellular wireless network, the indicator being transmitted, for example, in a Physical Downlink Control Channel (PDCCH), for example in a message in the PDCCH indicating an uplink grant. The indicator indicates a preferred basis of the signalling information relating to MIMO channel state information characteristics, for a downlink. The user equipment compiles the signalling information, such as channel state information (CSI), according to the preferred basis, and sends the compiled signalling information to the node. This has the advantage that the information is appropriate to the current usage of the downlink, for example appropriate to a single user MIMO, multi-user MIMO scheme and/or Low Power Node (LPN) or macro network layout. Flexibility of sub-band size, introduced in embodiments of the invention, for example by communicating sub-band size in the indicator, may be beneficial, for example for a LPN, since a LPN channel model is typically less frequency selective than a macro channel model. The preferred basis may comprise an indication relating to a rank of MIMO communications upon which the information is to be based, such an indication as to whether the rank is restricted to a pre-determined value or not, or an indication of a rank to be used as a basis for the information. The indicator may also indicate a frequency sub-banding arrangement on which one or more indications of channel quality, such as a Channel Quality Indicator (CQI) is to be based, and/or may indicate a frequency sub-banding arrangement on which one or more indications of a Precoding Matrix Index (PMI) is to be based.

In an embodiment of the invention, the indicator indicates on which of two or more pre-configured options of preferred bases the information should be based. This has the advantage that the indicator may be signalled efficiently, for example as a single bit.

In a first pre-configured option, for example, a rank of MIMO communications may be unrestricted by the pre-configuration, and/or an indication of channel quality, such as CQI, may relate to a whole frequency band rather than a sub-band of the frequency band, and/or a precoding matrix index (PMI) or indices is sub-banded, i.e the PMIs each relate to a sub-band of the frequency band.

In a second pre-configured option, for example, a rank of MIMO communications may be restricted by the pre-configuration to a pre-determined value, and/or an indication of channel quality, such as CQI, may be sub-banded, so that one or more CQIs relate to respective sub-bands of the frequency band, and/or a precoding matrix index (PMI) or indices is not sub-banded, i.e a PMI relates to the whole frequency band.

This has the advantage that, for example, the first option may be appropriate to a single-user MIMO scheme and the second option may be appropriate to a multi-user MIMO scheme, so that the node may select an appropriate option.

In an embodiment of the invention, the indicator may indicate which pre-configured option is to be selected by the position of the indicator in a frame, for example a transmission frame of the PDCCH.

In an embodiment of the invention, if the user equipment receives an indicator indicating that a rank of Multiple Input Multiple Output communications is restricted to a pre-configured value, and if it determines, for example by measuring channel quality, that a rank other than the pre-configured value of rank would be preferred, the user equipment sends a flag to the node indicating that a rank other than the pre-configured value of rank would be preferred. This has the advantage the user equipment may override a restriction on rank, for example by requesting a higher rank be used for download data, if channel quality is good, to make best use of the channel.

In an embodiment of the invention, the indicator indicates a maximum value of rank on which the user equipment should base the information relating to desired Multiple Input Multiple Output configuration characteristics. This maximum value of rank may be used, for example, when a restricted rank condition is indicated.

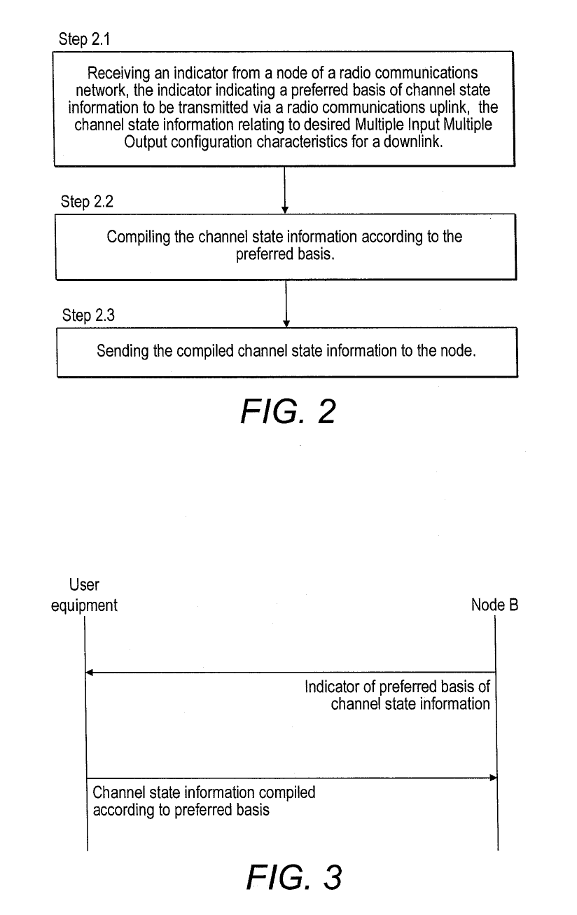

FIG. 2 is as flow diagram, illustrating an embodiment of the invention as steps 2.1, 2.2, and 2.3, as already described.

FIG. 3 is a diagram showing signalling flow in an embodiment of the invention. As illustrated, a NodeB sends an indicator of a preferred basis of channel state information. This indicator may be sent, for example, using a Physical Downlink Control Channel (PDCCH).

In an embodiment of the invention, the basis on which information, such as CSI, relating to desired MIMO configuration characteristics for a downlink may be determined as follows. For example, this may be applicable when the CSI is sent periodically rather than on the basis of an indicator received from the node. If the user equipment determines that the preferred rank to be used for the downlink is one, the information, such as CSI information, is sent in alternate messages indicating a closest and second closest codeword respectively. The first, which may be the closest, codeword is selected from a codebook to be a closest codeword in the codebook to a representation of an intended MIMO channel state information characteristic determined by the user equipment, and the second characteristic is selected to be a less close codeword in the codebook to the representation of the intended MIMO channel state information characteristic. The second characteristic can be any codeword from the codebook that after interpolation with first characteristic produces codeword closest to the representation of the preferred, that is to say intended, MIMO channel state information. This approach may have superior performance to sending just the first codeword, however it may require more complexity at the user equipment and interpolation methods may need to be identical at the user equipment and transmission point. The first and second codewords may represent information comprising a Precoding Matrix Index

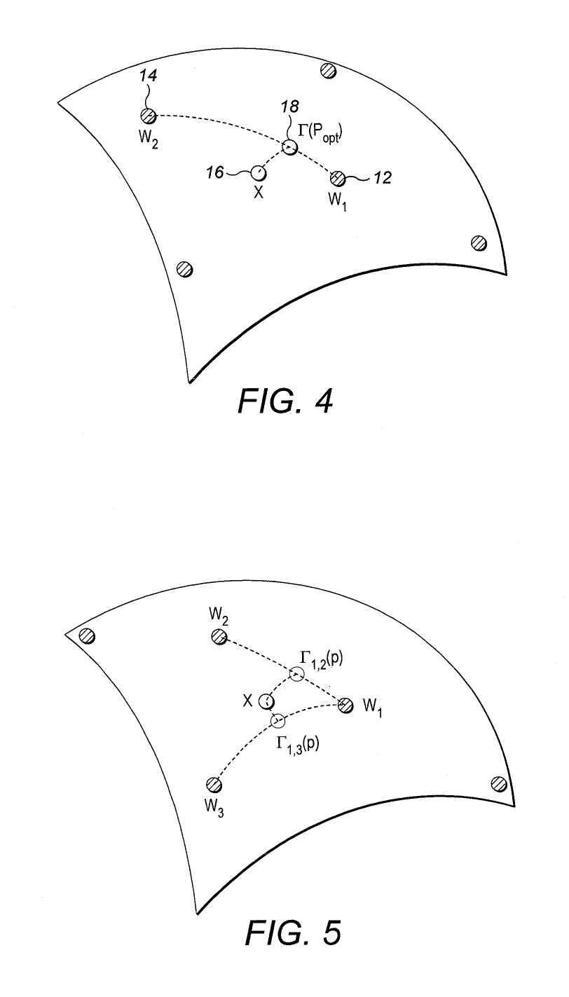

FIG. 4 is a diagram illustrating determination of closest 12 and second closest 14 codewords in an embodiment of the invention, showing a surface representing CSI values. Certain CSI values may be represented by codewords, chosen from a codebook of coded CSI values. The use of a codeword to represent a CSI value has the advantage that a CSI value may be communicated with less signalling overhead than would be needed to encode an arbitrary CSI value. An optimum that is to say intended, CSI characteristic, as determined by the user equipment as a preferred CSI characteristic, is shown as position X 16. This value may not correspond to a value represented exactly by an allowed code word. It can be seen that codeword W₁ 12 is the closest codeword to the preferred value 16 of CSI, codeword W₂ 12 is the second closest codeword to the preferred value 16 of CSI. In addition, as shown by FIG. 5, codeword W₃ may be a third closest codeword to the optimum value, which may be referred to as the intended value. By transmitting both W₁ and W₂, an interpolated value 18 of CSI may be calculated, that is closer the optimum value than either W₁ or W₂. As shown by FIG. 5, if the third closest codeword W₃ is also transmitted, an interpolated value based on interpolating W₁ and W₃ may be even closer to optimum the optimum value. The code word used for interpolation may be a n-th closest codeword to a representation of the intended channel state information characteristic, codeword Wₙ. The codewords typically represent channel state information including a Precoding Matrix Index

In an alternative embodiment of the invention, the reporting of first, second and/or n-th closest codewords in a CSI report may be used with aperiodic CSI reporting, rather than the periodic CSI reporting described above. An indicator sent to the user equipment may indicate a type of codeword to be used for reporting the signalling information, that may be the highest priority signalling information. The type of codeword may be selected from a set of types of codeword comprising at least a first type of codeword selected from a codebook to be a closest codeword in the codebook to a representation of an intended Multiple Input Multiple Output channel state information characteristic, and a second type of codeword selected from the codebook to be a less close codeword than the first type of codeword to the representation of the intended Multiple Input Multiple Output channel state information characteristic. The second type of codeword may be a second closest codeword in the codebook to the representation of the intended Multiple Input Multiple Output channel state information characteristic. The set of types of codeword may include a third type of codeword selected from the codebook to be a n-th closest codeword to the representation of the intended Multiple Input Multiple Output channel state information characteristic, where the factor n is indicator by the indicator.

In an embodiment of the invention, the second type of codeword is selected to be the codeword in the codebook that, together with the first type of codeword, produces an interpolated Multiple Input Multiple Output channel state information characteristic that is closest to the representation of the intended Multiple Input Multiple Output channel state information characteristic.

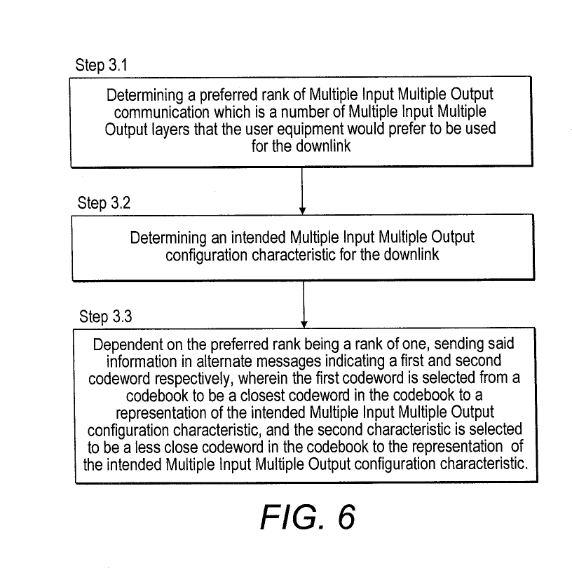

FIG. 6 is as flow diagram, illustrating an embodiment of the invention as steps 3.1, 3.2, and 3.3, as already described.

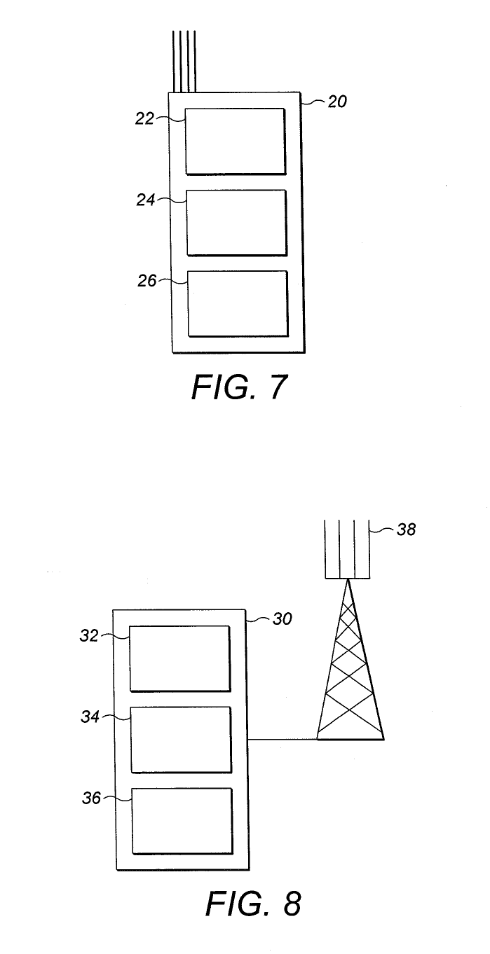

FIG. 7 illustrates a user equipment 20 according to an embodiment of the invention. A transceiver 22 is controlled by a processor 24 including a controller, which has access to a memory 26 on which instructions to carry out the steps of embodiments of the invention may be stored. A user equipment may be, for example, a mobile or cell phone (including a so-called “smart phone”), a personal digital assistant, pager, tablet or laptop computer, a content-consumption or generation device (for music and/or video for example), a data card, or USB dongles, etc.

FIG. 8 illustrates a node of the wireless network according to an embodiment of the invention. A module 30 comprises a transceiver 32 is controlled by a processor 34 including a controller, which has access to a memory 36 on which instructions to carry out the steps of embodiments of the invention may be stored. The module 30 is connected to an antenna unit 38, having a plurality of antennas. The node may, for example, be a nodeB of a HSPA cellular wireless network.

Embodiments of the invention will now be described in more detail.

In embodiments of the invention, CSI feedback enhancement alternatives are provided to current CSI feedback reporting modes. Several pre-configured, that is to say semi-statically configured, bases for CSI reporting have been proposed, as follows.

It has been found that multi user MIMO (MU-MIMO) is particularly suited to spatially correlated environments, for which wideband PMI reporting may be appropriate. The availability of frequency selective, i.e sub-banded CQI information has the advantage of allowing the use of frequency domain packet scheduling (FDPS) to provide performance gains, potentially together with multi-user diversity. So-called PUSCH mode 3-1 (wideband PMI/sub-band CQI) may be appropriate for downlink (DL) MU-MIMO operation. However, so-called PUSCH mode 1-2 (sub-band PMI/wideband CQI) may be appropriate to give frequency selective precoding gains for SU-MIMO but lacks the ability to capture FDPS gains because of the single wideband CQI component. So-called PUSCH feedback mode 3-2 comprises reporting sub-band (i.e. frequency selective) information for PMI and CQI. In addition, wideband CQI may also be reported. PUSCH mode 3-2 brings frequency selective PMI in addition to sub-band CQI reporting, but PUSCH mode 3-2, however, may have with a high UL feedback overhead because of frequency selective PMI information, which may require 4 bits per sub-band.

Variants of so-called multi-rank feedback may involve time multiplexing of rank restricted/non-restricted CSI reports.

Feeding back the best and second best codeword, and potentially a third best codeword, as already described by reference to FIGS. 4 and 5, may be used as refinement method for CSI. Referring again to FIG. 4, The X denotes perfect CSI displayed on the manifold, W₁ is the best, that is to say closest, codeword from a codebook C and W₂ is the second best, that is to say second closest, codeword. Intepolated precoder Γ(pₒₚₜ) lies on the geodesic between W₁ and W₂. As may be seen for FIG. 4, the Γ(pₒₚₜ) distance to X is smaller than distance between W₁ and X. The pₒₚₜ position on the geodesic is proportional to ratio of CQIs reported with best and second best PMI. The advantage of second best refinement to multi description coding is its very low complexity of selecting the second best codeword and the lack of a requirement for designing additional codebooks.

Current pre-configured schemes for rank indication (RI) reporting (e.g. with PUSCH 3-1, 3-2 or 1-2) may lead to sub-optimum MU-MIMO performance, particularly in case that the UE reports CSI for RI>1 and the eNB still schedules the UE in MU-MIMO, because it may then lack rank-1 PMI and corresponding CQI more optimum for such MU-MIMO scheduling. Furthermore, Rank-1 restricted CSI feedback in addition to CSI reporting with preferred RI may lead to redundant information and unnecessary overhead when UE supports rank-1 transmission mode for much of the time. PUSCH 1-2 reporting mode may be well-suited to SU-MIMO transmission for a single or a few UEs with large resource allocations, i.e. with lot of data to transmit. However, with an increased number of UEs the possibility of exploiting FDPS gains is lacking and dynamic SU-/MU-MIMO scheduling may not be performed on a per sub-frame basis. PUSCH 3-2 reporting mode may be appropriate to dynamic SU-MIMO and MU-MIMO scheduling, especially when the channel starts to decorrelate spatially and/or when the number of UEs is large. However, in the case that the UE reports CSI under PUSCH 3-2 with rank >1, the scheme may not satisfy its original intent of facilitating MU-MIMO scheduling. PUSCH 3-2 reporting also incurs high feedback overhead for SU-MIMO scheduling.

Time-multiplexed rank-restricted/non-restricted CSI feedback may incurs redundant feedback computations at the UE, leading to higher complexity, and increased power consumption.

Embodiments of the invention may address the disadvantages with existing CSI feedback mechanisms.

A first embodiment of the invention comprises a new aperiodic CSI feedback mode over the Physical Uplink Shared Channel (PUSCH) where the aperiodic CSI trigger, that is to say an indicator, in the uplink grant over PDCCH carries an indication of the requested transmission rank and/or feedback granularity in the frequency domain for CQI and/or PMI for the next CSI report, that is to say CSI feedback, which is signalling information relating to MIMO channel state information characteristics, over PUSCH. The signalling information may be signalling information that the user equipment determines to be highest priority for the downlink, rather than, for example, for a fallback position. In this way, the eNodeB can tailor dynamically the purpose of CSI feedback, for example for single user/multi-user MIMO (SU/MU-MIMO) scheduling, and adjust the accuracy and overhead of the feedback. For example, when sub-band information does not differ much from its wideband counterpart, wideband may be selected.

A second embodiment of the invention comprises a new CSI aperiodic feedback mode over PUSCH which consists of triggered rank-non-restricted (wideband CQI/sub-band PMI) or rank-restricted (sub-band CQI/wideband or sub-band PMI) feedback. This can be seen as a special case of the first embodiment with only two possible combinations of CQI/PMI reporting granularities and usage of rank restrictions. A single UE feedback mode combines the benefits of two existing CSI feedback modes, namely PUSCH 1-2 without rank-restriction targeting SU-MIMO and PUSCH 3-1/3-2 with rank restricted to ‘r’ targeting MU-MIMO. The CSI trigger may contain an explicit indication of which type of CSI feedback is requested next. The indication on the type of requested CSI feedback may be implicit, for example linked to known parameters such as a sub-frame index where CSI trigger is sent. In this case, the indicator, for example the CSI trigger, may indicate which of two or more pre-configured options is to be selected as the basis of signalling information by the position of the indicator within the frame.

In an embodiment of the invention, such an approach could be used also with periodic PUSCH feedback if such feedback is specified. In that case the two feedback types could be alternating over time based on a predefined pattern. If alternation between rank 1 and rank ‘r’ feedback is configured, the following options are possible. As a first option, rank-1 feedback may be alternated with 2^{nd} best rank-1 PMI/CQI feedback if UE's recommended rank equals 1. As a second option, rank-r CSI feedback may be alternated with rank-1 CSI feedback if UE's recommended rank equals ‘r’.

A third embodiment of the invention comprises a new aperiodic CSI feedback mode over PUSCH with sub-band CQI/sub-band PMI reporting, i.e. similar to PUSCH 3-2, together with restricted rank=r CQI/PMI reporting and with an implicit or explicit indication by the UE whether transmission rank other than ‘r’ (e.g. rank>r) would have superior performance by at least some predefined amount. The aperiodic CSI trigger in the uplink grant over PDCCH carries an indication (e.g. flag) to report CSI over PUSCH with the UE preferred rank thereby overriding restricted rank CSI reporting for the next requested CSI report.

Additionally, the CSI trigger may contain explicit information on the requested/restricted rank the UE should assume when performing rank-restricted CSI computations. A use case could be for eNB to “poll”/test UE performance under various ranks in order to decide whether a given UE would have overall more potential for either SU-/ or MU-MIMO scheduling.

Additionally, the CSI trigger may also contain an indication on the maximum rank (other than ‘r’) the UE should assume when performing non-rank-restricted CSI computations.

In an embodiment of the invention, a UE is semi-statically configured by the eNB to one of the proposed new transmission modes via higher-layer signalling. A UE receives an aperiodic CSI trigger as part of the uplink grant over PDCCH. In the case that the CSI feedback is configured to report CSI restricted to a given rank ‘r’, the UE computes and reports the corresponding CSI (CQI(s)/PMI(s)) in the next CSI reporting instance over PUSCH. Rank restriction may be configured semi-statically, or Rank restriction may be configured semi-statically together with a CSI refinement. The UE may alternate rank-1 and rank-1 second best PMI/CQI feedback if its reported rank equals 1, or alternatively, the UE may alternate rank-r and rank-1 CQI/PMI feedback if its reported rank equals ‘r’.

Rank restriction may be configured dynamically as part of the CSI trigger. The CSI trigger may contain explicit information on the restricted rank the UE should assume when performing rank-restricted CSI computations. In an embodiment of the invention, the explicit information is only one bit indicating whether restricted rank<=r or non-restricted rank should be assumed. The value of r may be configured via higher layers.

The CSI trigger may also contain an indication on the requested rank the UE should assume for CSI feedback in the next reporting instance over PUSCH. The CSI trigger may also contain an indication on the maximum rank (other than ‘r’) the UE should assume when performing non-rank-restricted CSI computations. In case that the configured CSI feedback mode involves an indication from eNB (explicit or implicit) to report with given frequency granularity for CQI and/or PMI, the UE computes and reports the corresponding CSI (CQI(s)/PMI(s)) in the next CSI reporting instance over PUSCH. In an embodiment of the invention, the frequency granularity for each of CQI and/or PMI may be explicitly indicated. In an embodiment of the invention, the frequency granularity for each of CQI and/or PMI may be either wideband or sub-band.

In an embodiment of the invention, if the configured CSI feedback mode involves an indication from eNB (explicit or implicit) to report either one of (wideband CQI/sub-band PMI) or (sub-band CQI/wideband PMI), the UE computes and reports the corresponding CSI (CQI/PMI) in the next CSI reporting instance over PUSCH. The CSI trigger may contain an explicit indication of which type of CSI feedback is requested next. The indication of the type of requested CSI feedback may be implicit, e.g. tied to known parameters such as sub-frame index where CSI trigger is sent. This approach could be used also with periodic PUSCH feedback if such feedback is specified. In that case the two feedback types could be alternating over time based on a predefined pattern.

In case the CSI feedback is configured to report CSI restricted to a given rank ‘r’, additionally to computing and reporting the corresponding CSI (CQI(s)/PMI(s)) in the next CSI reporting instance over PUSCH, the UE may evaluate the performance (e.g. in SU-MIMO context) associated with a rank other than ‘r’ (e.g. rank>r) by computing the associated CQI(s)/PMI(s) and may provides explicit or implicit signalling. For explicit signalling, the UE sets one flag indicating whether or not higher performance may be achieved by rank other than ‘r’ (e.g. rank>r). The threshold used to toggle such flag may be predefined or configured semi-statically in terms of e.g. percentage of throughput gain or in terms of increase in CQI classes. For implicit signalling, the UE may set the RI field of the CSI report over PUSCH to the value of the rank achieving better performance vs. restricted rank ‘r’, although the rest of the CSI report (i.e. PMI/CQI) may correspond to the rank requested by eNB. The CQI(s)/PMI(s) associated with the rank other than ‘r’ may be not reported as part of the next CSI report over PUSCH but may be requested by eNB at a future time.

In an embodiment of the invention, the eNB semi-statically configures the UE to one of the proposed new transmission modes via higher-layer signalling. The eNB may send an aperiodic CSI trigger to the UE as part of the uplink grant over PDCCH, and the eNB may configure CSI feedback restricted to a given rank ‘r’. Rank restriction may be configured semi-statically, or rank restriction may be configured dynamically as part of the CSI trigger in an embodiment of the invention. The CSI trigger may contain explicit information on the requested/restricted rank the UE should assume when performing rank-restricted CSI computations. In an embodiment of the invention, the explicit information may be only one bit indicating whether restricted rank<=r or non-restricted rank should be assumed. Here r may be configured via higher layers.

The CSI trigger may also contain an indication on the requested rank the UE should assume for CSI feedback in the next reporting instance over PUSCH. The CSI trigger may also contain an indication on the maximum rank (other than ‘r’) the UE should assume when performing non-rank-restricted CSI computations. The eNB may provide an indication to the UE (explicit or implicit) to report with given frequency granularity for CQI and/or PMI over PUSCH. In an embodiment of the invention, the frequency granularity for each of CQI and/or PMI may be explicitly indicated. In an embodiment of the invention, the frequency granularity for each of CQI and/or PMI may be either wideband or sub-band.

If the eNB indicates the UE to report either one of (wideband CQI/subband PMI) or (subband CQI/wideband PMI) over PUSCH, the CSI trigger may contain an explicit indication of which type of CSI feedback is requested next, or the indication on the type of requested CSI feedback may be implicit, e.g. tied to known parameters such as sub-frame index where CSI trigger is sent. Such an approach could be used also with periodic PUSCH feedback if such feedback is specified. In that case the two feedback types could be alternating over time based on a predefined pattern.

In an embodiment of the invention, the eNB may request the UE to report CSI restricted to a given rank ‘r’, and, additionally, eNB asks the UE to assess the performance (e.g. in SU-MIMO context) associated with a rank other than ‘r’ (e.g. rank>r) and to provide implicit or explicit signalling. In the case of explicit signalling, the eNB may request the UE to set one flag indicating whether or not higher performance may be achieved by rank other than ‘r’ (e.g. rank>r). The threshold used to toggle such flag may be predefined or configured semi-statically in terms of e.g. percentage of throughput gain or in terms of increase in CQI classes. In the case of implicit signalling, the eNB may request the UE to set the RI field of the next CSI report over PUSCH to the value of the rank achieving better performance vs. restricted rank ‘r’

Embodiments of the invention may provide less overall feedback overhead, and eliminate redundancies in multi-rank feedback. Embodiments of the invention are well suited to SU-/MU-MIMO operation with dynamic switching between the two modes, and to dynamic adaptation of CQI/PMI reporting granularity. More flexible operation of restricted rank feedback is provided which adapts more easily to rapid traffic fluctuations and usage of SU-MU-MIMO over time, and lower UE power consumption may result because less CSI calculations are needed, and a lower CSI feedback reporting rate can be applied.

If SU-MIMO scheduling information is not readily available for UEs which have good rank >1 performance, the eNB may modify its assumption on the fixed or maximum rank to request CSI feedback for example using RI & CSI reports over the PUCCH channel.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of transmitting, via a radio communications uplink from a user equipment to a node of a cellular wireless network, signalling information relating to Multiple Input Multiple Output channel state information characteristics, that the equipment determines to be highest priority for a downlink, the method comprising:
receiving an indicator from the node indicating a preferred basis of the highest priority signalling information;
compiling the highest priority signalling information according to the preferred basis; and
sending the compiled signalling information to the node.

2. A method according to claim 1, wherein the indicator is carried in a message in a Physical Downlink Control Channel indicating an uplink grant.

3. A method according to claim 1, wherein the preferred basis comprises an indication relating to a rank of Multiple Input Multiple Output communications upon which the highest priority signalling information is to be based.

4. A method according to claim 1, wherein the preferred basis comprises an indication of a frequency sub-banding arrangement on which one or more indications of channel quality is to be based.

5. A method according to claim 1, wherein the preferred basis comprises an indication of a frequency sub-banding arrangement on which one or more indications of a precoding matrix index is to be based.

6. A method according to claim 1, wherein the indicator indicates on which of two or more pre-configured options of preferred bases the highest priority signalling information should be based.

7. A method according to claim 6, wherein said two or more options comprise:
a first option in which a rank of Multiple Input Multiple Output communications is unrestricted by the pre-configuration and an indication of channel quality relates to a whole frequency band of the rather than a sub-band of the frequency band; and
a second option in which a rank of Multiple Input Multiple Output communications is restricted by the pre-configuration to a predetermined value by the node and a plurality of indications of channel quality each relate to a sub-band of the frequency band.

8. A method according to claim 7, wherein:
in the first option, a plurality of precoding matrix indices each relate to a sub-band of the frequency band; and
in the second option, a precoding matrix index relates to a whole frequency band rather than a sub-band of the frequency band.

9. A method according to claim 7, wherein:
in the first and second options, a plurality of precoding matrix indices each relate to a sub-band of the frequency band.

10. A method according to claim 6, wherein:
the indictor indicates which pre-configured option is to be selected as the basis of the highest priority signalling information by the position of the indicator in a frame.

11. A method according to claim 1, further comprising:
in response to receipt of an indicator indicating that a rank of Multiple Input Multiple Output communications is restricted to a pre-configured value and a determination that a rank other than the pre-configured value of rank would be preferred; and
sending a first flag to the node indicating that a rank other than the pre-configured value of rank would be preferred.

12. A method according claim 1, wherein the indicator indicates a maximum value of rank on which the user equipment should base the highest priority signalling information.

13. A method according to claim 1, wherein the indicator indicates a type of codeword to be used for reporting the highest priority signalling information, the type of codeword selected from a set of types of codeword comprising at least:
a first type of codeword selected from a codebook to be a closest codeword in the codebook to a representation of an intended Multiple Input Multiple Output channel state information characteristic; and
a second type of codeword selected from the codebook to be a less close codeword than the first type of codeword to the representation of the intended Multiple Input Multiple Output channel state information characteristic.

14. A method according to claim 13, wherein the second type of codeword is selected to be a second closest codeword in the codebook to the representation of the intended Multiple Input Multiple Output channel state information characteristic.

15. A method according to claim 13, wherein the set of types of codeword further comprises a third type of codeword selected from the codebook to be a n-th closest codeword to the representation of the intended Multiple Input Multiple Output channel state information characteristic, wherein the factor n is indicator by the indicator.

16. A method according to claim 13, wherein the second type of codeword is selected to be the codeword in the codebook that together with the first type of codeword produces an interpolated Multiple Input Multiple Output channel state information characteristic that is closest to the representation of the intended Multiple Input Multiple Output channel state information characteristic.

17. A user equipment for transmitting to a node of a cellular wireless network, via a radio communications uplink, signalling information relating to Multiple Input Multiple Output channel state information characteristics, that the equipment determines to be highest priority for a downlink, the user equipment comprising at least one processor and at least one memory including computer program code, the at least one memory and the computer program code configured to, with the at least one processor, cause the user equipment to:
receive an indicator from the node indicating a preferred basis of the highest priority signalling information;
compile the highest priority signalling information according to the preferred basis; and
send the compiled signalling information to the node.

18. A method of transmitting, via a radio communications uplink from a user equipment to a node of a cellular wireless network, signalling information relating to a Multiple Input Multiple Output channel state information characteristics for a downlink, the method comprising:
determining a preferred rank of Multiple Input Multiple Output communication which is a number of Multiple Input Multiple Output layers that the user equipment would prefer to be used for the downlink; and
dependent on the preferred rank being a rank of one, sending said signalling information in different messages indicating a first and second codeword respectively,
wherein the first codeword is selected from a codebook to be a closest codeword in the codebook to a representation of an intended Multiple Input Multiple Output channel state information characteristic, and the second characteristic is selected to be a less close codeword in the codebook to the representation of the intended Multiple Input Multiple Output channel state information characteristic.

19. A method according to claim 18, wherein the second codeword is selected to be the codeword in the codebook that together with the first codeword produces interpolated Multiple Input Multiple Output channel state information characteristic that is closest to the representation of the intended Multiple Input Multiple Output channel state information characteristic

20. A user equipment for transmitting to a node of a cellular wireless network, via a radio communications uplink, signalling information relating to a Multiple Input Multiple Output channel state information characteristic for a downlink, the user equipment comprising at least one processor and at least one memory including computer program code, the at least one memory and the computer program code configured to, with the at least one processor, cause the user equipment to:
determine a preferred rank of Multiple Input Multiple Output communication which is a number of Multiple Input Multiple Output layers that the user equipment would prefer to be used for the downlink; and
dependent on the preferred rank being a rank of one, send said signalling information in different messages indicating a first and second codeword respectively,
wherein the first codeword is selected from a codebook to be a closest codeword in the codebook to a representation of the an intended Multiple Input Multiple Output configuration characteristic, and the second characteristic is selected to be a less close codeword in the codebook to the representation of the intended Multiple Input Multiple Output configuration characteristic.
